(19) United States
(12) Patent Application Publication
(10) Pub. No.: US 2012/0066045 A1
(43) Pub. Date: Mar. 15, 2012

(54) System and Method for Dynamically Identifying, Prioritizing and Offering Reward Categories

(75) Inventors: Donald H. Schmitt, Greenville, DE (US); Brian S. Gantert, Hockessin, DE (US); Elizabeth Gula, Lincoln University, PA (US); Douglas A. Filak, Hockessin, DE (US); Stacy M. Hamilton, Avondale, PA (US)

(73) Assignee: JPMorgan Chase Bank, N.A., New York, NY (US)

(21) Appl. No.: 13/279,685

(22) Filed: Oct. 24, 2011

Related U.S. Application Data
(62) Division of application No. 11/686,203, filed on Mar. 14, 2007.
Application No. 11/686,203 is a continuation-in-part of application No. 11/634,159, filed on Dec. 6, 2006.
Application No. 11/634,159 is a continuation-in-part of application No. 10/284,394, filed on Oct. 31, 2002, now Pat. No. 7,689,504.
(60) Provisional application No. 60/822,609, filed on Aug. 16, 2006.
(60) Provisional application No. 60/330,871, filed on Nov. 1, 2001.
(60) Provisional application No. 60/842,015, filed on Sep. 5, 2006.
(60) Provisional application No. 60/822,611, filed on Aug. 16, 2006.

(51) Int. Cl. G06Q 30/02

(52) U.S. Cl. 705/14.25

(57) ABSTRACT

A method for identifying and offering rewards is provided. A user's transaction history or category history, such as, for example, spending history, transaction history, merchant history, purchases history, services history, product history, channel history, frequency of spending history, SKU history, redemption history, reward earnings history, earning levels, reward categories, or currency type, currency history, customer responses to questions, and/or other data or information that enables identification of relevant rewards is determined. Next, at least one reward category based on the user's transaction history or reward category history is dynamically prioritized, and at least one top reward category based on the dynamic prioritizing of the at least one reward category is determined. Finally, the user is dynamically rewarded discounts, rebates, coupons, or other reward incentives based on the least one top reward category.

### RELATED APPLICATIONS

This application is a divisional of U.S. patent application Ser. No. 11/686,203, filed Mar. 14, 2007, which is a continuation-in-part of: (1) U.S. patent application Ser. No. 11/634,159, filed Dec. 6, 2006, titled “System and Method for Offering Reward Programs, which claims priority to U.S. Provisional Application No. 60/822,609, filed on Aug. 16, 2006, and titled “System and Method for Offering Reward Programs”; and (2) U.S. patent application Ser. No. 10/284,394, filed Oct. 31, 2002, titled “System and Method for Establishing or Modifying and Account with User Selectable Terms,” which claims priority to U.S. Provisional Application Ser. No. 60/330,871, filed Nov. 1, 2001, titled “System and Method for Establishing or Modifying an Account with User Selectable Terms.” U.S. patent application Ser. No. 11/686,203 also claims priority to: (1) U.S. Provisional Application No. 60/842,015, filed on Sep. 5, 2006, and titled “System and Method for Dynamically Identifying, Prioritizing And Offering Reward Programs,” and (2) U.S. Provisional Application No. 60/822,611, filed on Aug. 16, 2006, and titled “System and Method for Dynamically Identifying, Prioritizing and Offering Reward Programs.” The specification and drawings of each of the above applications are incorporated herein by reference in their entirety. Although not specifically recited herein, one of ordinary skill in the art would readily appreciate that the various systems and methods described herein may interact or cooperate with the systems and methods described in the above applications to carry out features and functionality related to the identification, prioritization and offering of relevant reward categories and programs.

### FIELD OF THE INVENTION

The present invention relates to the dynamic identification, offering and awarding of rewards. More particularly, the present invention relates to systems and methods that enable card issuers or sponsors, for example, to dynamically identify, prioritize and offer its customers relevant rewards based on customer transactions, and reward category history, such as, for example, spending history, transaction history, merchant history, purchases history, services history, product history, channel history, frequency of spending history, SKU history, redemption history, reward earnings history, earning levels, reward categories, currency type (e.g., points, miles or cash), currency history, customer queries, customer selections, customer responses to questions, customer preferences, any other particular related to a reward category, and/or other data or information that enables identification of relevant rewards.

### BACKGROUND

Rewards programs are becoming increasingly popular. Card issuers, such as banks, for example, commonly offer their customers reward cards (e.g., credit cards, debit cards, stored value cards, or gift cards) that are associated with particular rewards that aim to encourage or induce customer use by rewarding all or select transactions. Rewards are typically based on any number of transaction particulars, such as spending levels, types of transaction, identity of merchant or vendor, location of transactions, or any other data or information that demonstrates user behavior. For example, a card issuer may provide incentives (e.g., rebates or discounts) on purchases made through a particular vendor or merchant. Rewards may also include cash-back deals where the customer earns a percentage of the transaction amounts as cash value that gets added to the card member's account.

In some cases, reward cards may be “branded” with the name of a particular sponsor or merchant so that use of the card earns the customer points that may be redeemed through the sponsor or merchant. For example, a credit card sponsored by an airline may reward the user with airline miles that may be redeemed for free or discounted travel. Likewise, some cards earn store dollars that can be used as virtual cash to make purchases through select merchants and vendors.

Although conventional systems and methods enable card-issuers and sponsors to provide customers with a wide variety of reward earning opportunities, they nonetheless suffer from several notable drawbacks. For example, current systems and methods do not enable card-issuers and sponsors to dynamically identify, prioritize and offer card members with relevant reward earnings on an ongoing basis. Existing systems and methods depend primarily on mass mailings and other like marketing techniques to generate interest in rewards program. Once a card member subscribes to a particular reward program, there is no known system or technique for ensuring that reward earnings/program remain relevant to the card member in the future, or for revising reward earnings/program should needs or circumstances change. As a result, many potential reward earning marketing opportunities go unrealized resulting in diminished value for reward programs in general.

Thus, what is needed is a reward system and method that enables a card issuer or sponsor to dynamically identify, prioritize and offer card members relevant reward earnings/program based on customer particulars, such as demonstrated customer transaction history and expressed customer interests and needs.

### SUMMARY OF THE INVENTION

According to various embodiments, the systems and methods described herein may allow card issuers, sponsors, or card members, for example, to dynamically evaluate or reevaluate card member transaction and associated category history (e.g., spending history, transaction history, merchant history, purchases history, services history, product history, channel history, frequency of spending history, SKU history, redemption history, reward earnings history, earning levels, reward categories, currency type (e.g., points, miles or cash), currency history, customer responses to questions, any other particular related to a reward category, and/or other data or information that enables identification of relevant rewards), and thereafter dynamically switch the card member to reward(s) that are better suited to a his or her particular needs or demonstrated interests. For example, the various systems and methods described herein may be used by a card issuer, for example, to introduce a promotion whereby a card member is rewarded in relation to the card member's demonstrated behavior, as evidenced, for example, by the types of transactions conducted by the card member over a period of time, the total amount spent by the card member in purchases, the specific products or services (or categories of products or services) the card member routinely purchases, the types of rewards the card member has historically preferred or actually redeemed in the past, and any other data or information that may be used to particularly identify reward earning opportunities that may be of general or particular interest to the card member.

To this end, the various systems and methods described herein may dynamically identify, prioritize and offer reward(s) that are relevant to a particular card member's needs or demonstrated interests. In some embodiments, the various systems and methods described herein may process a card member's transactions and thereafter dynamically reward the card member according to a particular listing of rewards, such as, for example: (1) restaurant discounts, (2) grocery discounts, and (3) gas discounts. In some embodiments, the various systems and methods described herein may prioritize or order the rewards such that transactions with restaurants, grocery stores, and gas stations receive 10%, 7% and 5% discounts, respectively. Other reward schemes are of course possible.

In some embodiments, the particular rewards offered to a card member, for example, as well as their priority or ordering, may be based on the card member's preferences, or dynamically determined based on particulars about the card member, such as, for example, biographical or demographic information about the card member, the card member's transaction history or reward category history (e.g., spending history, transaction history, merchant history, purchases history, services history, product history, channel history, frequency of spending history, SKU history, redemption history, reward earnings history, earning levels, reward categories, currency type (e.g., points, miles or cash), currency history, customer queries, customer preferences, customer responses to questions, any other particular related to a reward program, and/or other data or information that enables identification of relevant rewards), or any other data or information that may be used to identify, prioritize or order reward earnings. For example, it may turn out that a card member having a card that rewards cash-back on movie rentals may frequently use the card in grocery stores. The various systems and methods described herein may then dynamically reward the card member for purchases made at a grocery store, or, if the customer is already receiving such rewards, the rewards may be moved to the top of the priority listing so that the card member may realize greater rewards for his or her related transactions.

In some embodiments, the various systems and methods described herein may enable the switching of rewards or rewards priorities or ordering without the card member losing earned points/miles/cash or any rewards value (e.g., miles, points, widgets, or any other unit have value). For example, if a card member earned 500 points through a theme park rewards program associated with a particular card, the systems and members described herein may switch the card member to a movie rental reward category along with the 500 points. In some embodiments, rewards value (e.g., points) may be transferred one-to-one or according to a predetermined or specified conversion rate. For example, a proprietary currency for a theme park card may be converted to a proprietary currency for retailer card (e.g., exchange or conversion rate). In some embodiments, the systems and methods described herein may transfer or convert value (e.g., points) between two different types of rewards programs, as distinguished between “universal” rewards value that effectively comprise merely a single rewards program.

The systems and methods described herein may also process rewards programs that are not points-based, such as a card where a percentage of money spent is applied to a college fund, for example, or a card that allows one to have specified use privileges (e.g., use airline lounge for free). In this situation, an appropriate exchange rate may be applied in converting or changing the rewards program. Also, the card member need not lose or close out his or her initial card, only the rewards program may change. This way, the card member may still enjoy other particulars of the card, such as the minimum monthly payment or interest rate, for example.

In some embodiments, the various systems and methods described herein may operate on the basis of a category of rewards that are associated with a card member. For example, a particular card member may be associated with any number of reward categories, such as five categories, for example: (1) gasoline; (2) dining; (3) purchases at a particular retailer; (4) groceries; and (5) travel. In some embodiments, a reward category may be based on any particular associated with demonstrated card member transactions, such as, for example, particular points-of-sale (“POS”), merchants, products or services purchases. In some embodiments, the top reward categories where the card member spends the most or conducts the most transactions, for example, will be the categories through which the card member receives rewards.

The systems and methods can then determine the earning rate that will be assigned to that transaction. For example, a card member may have the following categories associated with a particular credit card: (1) gasoline, (2) dining, and (3) video rentals, each one initially associated with 2% rewards earned per dollar spent in these categories. In some embodiments, the various systems and methods described herein may then revise the earning rate corresponding to some or each of the three categories. For example, if the card member spends more money or has more transactions at gasoline stations then at any of the other categories, the earning rate for gas purchases may be raised to 5%. Other earning rate changes are of course possible. In some embodiments, earning rates may apply to individual categories, such as is the case with the example provided in this paragraph, or to groups of categories.

In some embodiments, the various systems and methods described herein enable a card member to earn identical rewards in different currencies. For example, a card member can earn rewards for the top categories in cash, points, miles, or any other measure of value that can be accumulated and redeemed pursuant to relevant reward program(s). In some embodiments, a card member can select which particular currency he or she prefers, which selection can be subsequently changed by the card member or according to the card member's transaction history. In some embodiments, the various systems described herein can then optimize the card member's dynamic earnings based on the card member's previous purchasing transactions.

For example, a card member may earn 3% (e.g., cash) in the three merchant categories (out of fifteen), for example, where the card member spends the most or has the most transactions within a period of time, such as a month, for example. Thus, in January, 2006, the card member may earn 3% at gas stations, grocery stores and dry cleaning because of the card member's transaction history during December, 2005. Next month, however, the card member may continue to earn 3% at gasoline stations, grocery stores and department stores, for example, based on the card member's transaction history during January, 2006. The next month, the card member may have a different set of transactions, such as, for example, (1) bookstores, (2) restaurants and (3) video rentals. If the card member has earned a total of $150 in his or her rewards bank, but decides to take a trip for spring break, he or she could transfer the rewards into points (e.g., 15,000 points), or any other form of rewards value. The next month, therefore, the card member would be earning reward value in points.

In some embodiments, the various systems and methods described herein can determine or identify customer behavior (e.g., transactions) on different levels or granularity. In some embodiments, a customer transaction can be identified by the merchant category code, a particular merchant, a particular terminal at a merchant, a product code, or any other identifier comprising data or information that may be used to prioritize, arrange or associate reward categories or earning rates as described herein.

In some embodiments, the various systems and methods described herein enable a card member to earn his or her choice of a percentage of amount spent, or a designated number of points or other quantifiable reward unit or value. For example, a card member could be given the choice of earning 3% of transaction value or three (3) points. Card member A, for example, may say he wants to earn cash, while card member B may prefer points. Even though both card members are earning different rewards, they are earning identical value and could switch between cash and points. For example, if card member B had 5,000 points he could selectively convert this amount to $50.00. In so doing, however, the dynamic nature of his spending and other transaction behavior still carries through, regardless of the actual value or rewards being realized. In some embodiments, a card member may designate particular types of transactions that should earn points and which should earn cash. For example, a card member could be notified (e.g., on his or her monthly statement) that he or she has 10,000 points or $100 that are redeemable based on reward earnings.

In some embodiments, the reward that is awarded may comprise a reduced annual percentage rate (“APR”) or other pricing scheme. Thus, purchases made using the card in the categories where it is most frequently used would receive a lower APR or other pricing advantage. In some embodiments, the user's transaction history or reward category history may be evaluated every six (6) months or other predetermined period of time, for example, so that reduced APR may be effective for a sufficient period of time. For example, purchases made at gas stations, book stores and grocery stores—the top three destinations for a card holder during the past six months (based on number of transactions or total amount spent, for example)—would receive a lower APR or other pricing advantage over purchases made at other destinations.

In some embodiments, the various systems and methods described herein can determine or identify customer behavior (e.g., transactions) on different levels or granularity. In some embodiments, a customer transaction can be identified by the merchant category code, a particular merchant, a particular terminal at a merchant, a product code, or any other identifier comprising data or information that may be used to prioritize, arrange or associate reward categories or earning rates as described herein.

According to one embodiment of the invention, a method for identifying and offering rewards is provided. The method comprises the steps of: determining a user's transaction history or reward category history; dynamically prioritizing at least one reward category based on the user's transaction history or reward category history; determining at least one top reward category based on the dynamic prioritizing of the at least one reward category; and dynamically rewarding the user discounts, rebates, coupons, or other reward incentives based on the least one top reward category.

In yet another embodiment of the invention, a method for identifying and offering rewards is provided. The method comprises the steps of: determining at least one initial reward category associated with a user, wherein the at least one reward earning method is used to offer the user discounts, rebates, coupons, or other reward incentives; determining the user's transaction history or reward category history; and revising or prioritizing the at least one initial reward earning method based on the user's transaction history or reward category history, wherein revising or prioritizing the at least one initial reward earning method occurs without the user's input.

In yet another embodiment of the invention, a system for dynamically identifying, prioritizing and offering rewards is provided. The system comprising: a processor for processing data or information relating to a user's transactions; a processor for identifying at least one reward earning method based on the user's transaction; a processor for prioritizing or ordering the least one reward earning method; and a processor for applying the prioritized or ordered at least one reward earning method to the user's subsequent transaction.

In yet another embodiment of the invention, a method for identifying and offering rewards is provided. The method comprising the steps of: determining a user's transaction history or reward earning history; recommending or suggesting at least one reward earning method to the user based on the user's transaction history or reward earning history; receiving a response from the user relating to recommended or suggested at least one reward category; and revising or prioritizing the user's reward categories based on the user's response.

In yet another embodiment of the invention, a method for identifying and offering rewards is provided. The method comprising the steps of: determining a user's transaction history or reward earning history; dynamically prioritizing at least one reward earning method based on the user's transaction history or reward earning history; determining at least one top reward earning method based on the dynamic prioritizing of the at least one reward earning method; dynamically rewarding the user reward incentives in a first currency based on the least one top reward earning method, the user having a reward incentive balance of redeemable reward value; and switching the user to a second currency for earning reward incentives, wherein switching the user comprises converting the reward incentive balance into an equivalent reward value in the second currency and rewarding future user behavior in the second currency.

In some embodiments of the invention, the various systems and methods described herein, rather than automatically enrolling a user, may offer the user a recommended or suggested reward earning method(s) based on the user's transaction or reward earning history, for example. The user may then decide whether to switch or enroll in to the recommended or suggested reward earning method(s). If the user opts to enroll in the recommended or suggest reward earning method(s), the various systems and methods described herein may then prioritize or order the user's reward earning method(s) accordingly. Reward earning method recommendations or suggestions may be made randomly, periodically, or according to any predetermined or desired schedule.

In some embodiments, the various systems and methods described herein may permit a user to specify future activity or behavior and based thereon recommend or suggest reward category(ies) that may be of interest to the user based on the future activity or behavior. For example, if the user is going on vacation in the next month or so, the various systems and methods described herein may recommend or suggest particular reward category(ies) that may relate to the user's vacation plans. Other future activity or behavior is of course possible.

Other embodiments may also be considered.

### BRIEF DESCRIPTION OF THE DRAWINGS

FIG. 1 shows an exemplary system 100 for offering rewards, according to various embodiments of the invention.

FIG. 2 illustrates various exemplary modules that may be associated with central rewards program station 105, according to various embodiments of the invention.

FIG. 3 illustrates an exemplary process flow 300 for offering rewards, according to various embodiments of the invention.

FIG. 3a illustrates particular substeps of the process flow 300 illustrated in FIG. 3.

FIG. 4 illustrates an exemplary process flow 400 for offering rewards, according to various embodiments of the invention.

FIG. 5 illustrates an exemplary process flow 500 for offering rewards, according to various embodiments of the invention.

FIG. 6 illustrates a process flow 600 for offering rewards programs, according to various embodiments of the invention.

FIG. 7 illustrates a process flow 700 for converting value (e.g., points) associated with rewards programs, according to various embodiments of the invention.

FIG. 8 illustrates a process flow 800 for offering rewards programs, according to various embodiments of the invention.

FIG. 9 illustrates a process flow 900 for offering rewards programs, according to various embodiments of the invention.

FIG. 10 illustrates a process flow 1000 for identifying and offering rewards, according to various embodiments of the invention

### DETAILED DESCRIPTION OF EXEMPLARY EMBODIMENTS

Reference will now be made to the present preferred embodiments of the invention, examples of which are illustrated in the accompanying drawings in which like reference characters refer to corresponding elements.

The present invention is described in relation to a system and method for identifying, prioritizing and offering rewards earning methods. Nonetheless, the characteristics and parameters pertaining to the system and method may be applicable to transactions associated with other types of rewards.

While the exemplary embodiments illustrated herein may show the various embodiments of the invention (or portions thereof) collocated, it is to be appreciated that the various components of the various embodiments may be located at distant portions of a distributed network, such as a local area network, a wide area network, a telecommunications network, an intranet and/or the Internet, or within a dedicated object handling system. Thus, it should be appreciated that the components of the various embodiments may be combined into one or more devices or collocated on a particular node of a distributed network, such as a telecommunications network, for example. As will be appreciated from the following description, and for reasons of computational efficiency, the components of the various embodiments may be arranged at any location within a distributed network without affecting the operation of the respective system.

Among many potential uses, the systems and methods described herein may be used to: (1) induce customer loyalty by dynamically identifying, prioritizing and offering to customers relevant reward category offers based on customer behavior (e.g., past transactions), and other factors, such as, for example, favorite or repeat merchants, location of transactions, spending levels, biographical or demographic information, or any other data or information that may be used to particularize or focus offers or ordering of reward categories; (2) allow card members to efficiently and dynamically switch between loyalty programs, either through the same or different card; (3) allow issuers and sponsors, for example, to efficiently update and revise their affiliated reward categories; (4) allow conversion of rewards between different reward categories; (5) allow centralized coordination and offering of multiple reward categories; (6) track customer transactions and decision-making to enhance the resolution and precision of reward category offers; and (7) allow a third party (e.g., a bank or other financial institution) to administer and coordinate the offering of relevant reward category offers; (8) allow a user to specify future activity, behavior or transactions which the various systems and methods can then use to recommend or suggest relevant reward category(s). Other uses are possible.

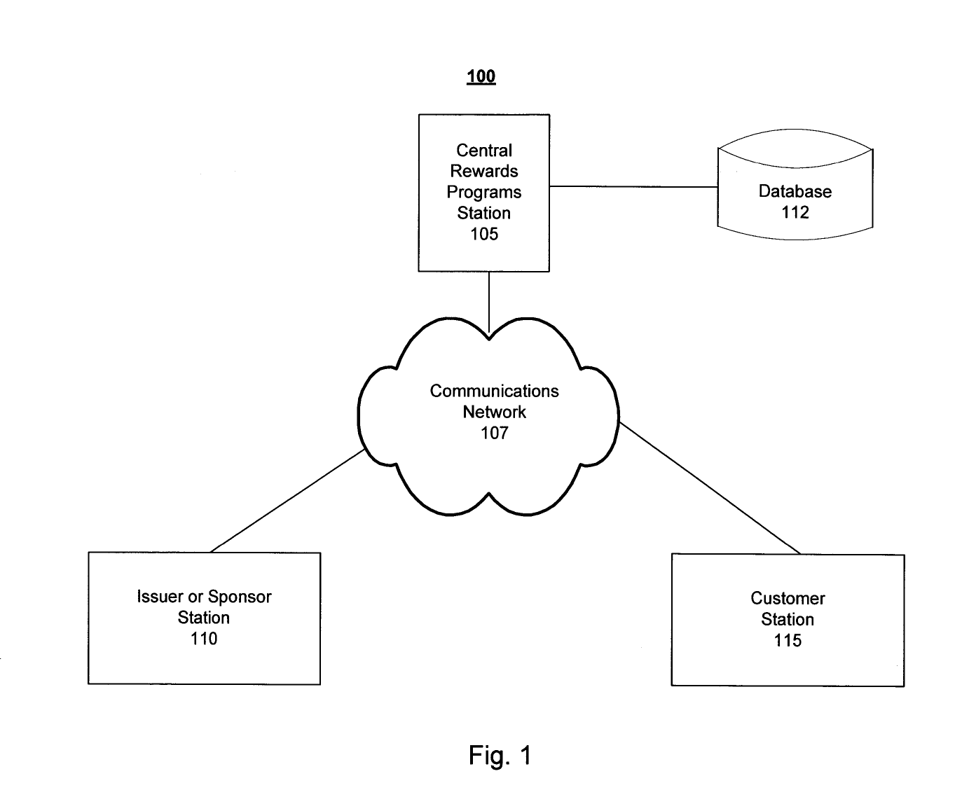

FIG. 1 illustrates a system 100 for offering reward categories according to one embodiment of the invention. System 100 may comprise a central reward category station 105 for identifying and offering reward categories based on customer (e.g., card member) particulars, such as past transactions and expressed interests and needs. In some embodiments, central rewards programs station 105 may be administered by a bank or financial institution that issues and administers cards (e.g., a card-issuer), a merchant or vendor that sponsors a reward category (e.g., a sponsor), or any third party that coordinates, manages or administers customer interaction with merchants 110 via cards and corresponding rewards programs. In some embodiments, central rewards programs station 105 may maintain particulars about card members, reward categories, sponsors, and any data and information that may be used to identify and offer reward categories according to the systems and methods described herein. In some embodiments, central rewards program station 105 may comprise the central headquarters or repository of the various features and functions of the systems and methods described herein, and may be maintained by any party or entity that administers the coordination of data and information in connection with the identification and offering of reward categories according to the systems and methods described herein.

Central rewards programs station 105 may comprise a single server or engine (as shown). In another embodiment, central rewards programs station 105 may comprise a plurality of servers or engines, dedicated or otherwise, which may further host modules for performing desired system functionality. Central rewards programs station 105, for example, may host one or more applications or modules that function to permit interaction between the users of system 100 (e.g., sponsors, customers, the administrator of central rewards programs station 105, and any other relevant parties) as it relates to exchanging and processing of data and information related to the identification and offering of reward categories, for example. For instance, central rewards programs station 105 may include an administration module that serves to permit interaction between the system 100 and the individual(s) or entity(ies) charged with administering system 100 or central rewards programs station 105. Such an administration module may enable the agent of central rewards programs station 105, for example, to input information related to reward categories, including but not limited to parameters used to determine which reward categories to offer to a customer, and how such reward categories are to be prioritized or ordered for purposes of reward accumulation. Such parameters may comprise variables that define a particular pool or segment of customers that may be dynamically presented with a particular reward category. Thus, a reward category offering 10% discounts on groceries should be dynamically offered to card members that through past transactions, for example, demonstrate a high frequency of grocery shopping via the card. This way, reward categories may be properly targeted and focused on card-members most inclined to appreciate and benefit therefrom.

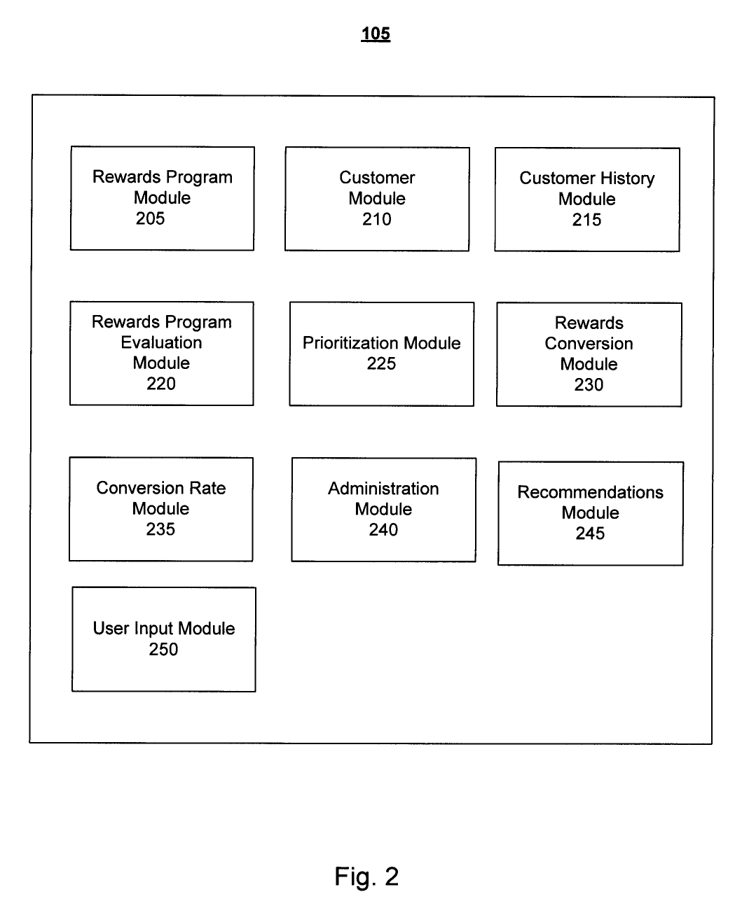

According to various embodiments, an agent of central rewards programs station 105 may interface with a graphical user interface (or GUI) to input: (1) data or information (e.g., terms, words, phrases, or digits) that enable the agent to define particular pools of customers, (2) data or information that enable the agent to define particular reward categories, (3) data or information that enable the agent to define particulars about sponsors through which the reward categories will be delivered, (4) rules, parameters and algorithms used to identify which reward categories to offer to customers, and (5) particulars about converting rewards between various reward categories, including, for example, maintaining and updating conversion rates. An agent of central rewards program station 105 may also input information or data regarding how reward categories are stored (e.g., categorized) in a database 112, for example. Other modules may permit processing of the various features and functionality described herein for identifying and offering reward categories (See FIG. 2 for modules associated with central rewards program station 105).

Central rewards programs station 105 may include, for instance, a workstation or workstations running the Microsoft Windows™ XP™ operating system, Microsoft Windows™ NT™ operating system, the Windows™ 2000 operating system, the Unix operating system, the Linux operating system, the Xenix operating system, the IBM AIX™ operating system, the Hewlett-Packard UX™ operating system, the Novell Netware™ operating system, the Sun Microsystems Solaris™ operating system, the OS/2™ operating system, the BeOS™ operating system, the Macintosh operating system, the Apache operating system, an OpenStep™ operating system or another operating system or platform.

Data and information maintained by central rewards program station 105 may be stored and cataloged in database 112 which may comprise or interface with a searchable database. Database 112 may comprise, include or interface to a relational database. Other databases, such as a query format database, a Standard Query Language (SQL) format database, a storage area network (SAN), or another similar data storage device, query format, platform or resource may be used. Database 112 may comprise a single database or a collection of databases, dedicated or otherwise. In one embodiment, database 112 may store or cooperate with other databases to store the various data and information described herein. In some embodiments, database 112 may comprise a file management system, program or application for storing and maintaining data and information used or generated by the various features and functions of the systems and methods described herein. In some embodiments, database 112 may store, maintain and permit access to customer information, sponsor or reward category information, and general information used to identify and offer reward categories, as described herein.

Central rewards station 105 may, in some embodiments, be accessed via a communication network 107. Communications network 107 may be comprised of, or may interface to any one or more of, the Internet, an intranet, a Personal Area Network (PAN), a Local Area Network (LAN), a Wide Area Network (WAN), a Metropolitan Area Network (MAN), a storage area network (SAN), a frame relay connection, an Advanced Intelligent Network (AIN) connection, a synchronous optical network (SONET) connection, a digital T1, T3, E1 or E3 line, a Digital Data Service (DDS) connection, a Digital Subscriber Line (DSL) connection, an Ethernet connection, an Integrated Services Digital Network (ISDN) line, a dial-up port such as a V.90, a V.34 or a V.34bis analog modem connection, a cable modem, an Asynchronous Transfer Mode (ATM) connection, a Fiber Distributed Data Interface (FDDI) connection, or a Copper Distributed Data Interface (CDDI) connection.

Communications network 107 may also comprise, include or interface to any one or more of a Wireless Application Protocol (WAP) link, a General Packet Radio Service (GPRS) link, a Global System for Mobile Communication (GSM) link, a Code Division Multiple Access (CDMA) link or a Time Division Multiple Access (TDMA) link such as a cellular phone channel, a Global Positioning System (GPS) link, a cellular digital packet data (CDPD) link, a Research in Motion, Limited (RIM) duplex paging type device, a Bluetooth radio link, or an IEEE 802.11-based radio frequency link. Communications network 107 may further comprise, include or interface to any one or more of an RS-232 serial connection, an IEEE-1394 (Firewire) connection, a Fibre Channel connection, an infrared (IrDA) port, a Small Computer Systems Interface (SCSI) connection, a Universal Serial Bus (USB) connection or another wired or wireless, digital or analog interface or connection.

In some embodiments, communication network 107 may comprise a satellite communications network, such as a direct broadcast communication system (DBS) having the requisite number of dishes, satellites and transmitter/receiver boxes, for example. Communications network 107 may also comprise a telephone communications network, such as the Public Switched Telephone Network (PSTN). In another embodiment, communication network 120 may comprise a Personal Branch Exchange (PBX), which may further connect to the PSTN.

As shown in FIG. 1, issue or sponsor station 110 and card member station 115 may communicate central reward category station 105 via communication network 107. Issue or sponsor station 110 may comprise, for example, a station utilized by an agent of a card issuer or a sponsor to interact or communicate with card members. For example, station 110 may comprise a call center facility or station of a card issuer or sponsor that is manned by an operator to receive calls from card members. In some embodiments, issue or sponsor station 110 may comprise or host web sites or web pages of the card issuer or sponsor that a card member can access to interact with or engage the various features or functionality associated with the card.

Card member station 115 may, in some embodiments, enable a card member to interact with and communication a card issuer or sponsor as represented by issuer or sponsor station 110. For example, card member station 115 may enable a card member to call or access the web site or page of a card issuer or sponsor to inquire about account particulars, make payment on an account, or inquire about available balance, for example. In some embodiments, card member station 115 may comprise any terminal (e.g., a typical home or personal computer system) whereby a card member may interact with a network, such as communications network 205, for example, that is responsible for transmitting and delivering data and information used by the various systems and methods described herein. Card member station 115 may comprise or include, for instance, a personal or laptop computer. Card member station 115 may include a microprocessor, a microcontroller or other general or special purpose device operating under programmed control. Card member station 115 may further include an electronic memory such as a random access memory (RAM) or electronically programmable read only memory (EPROM), a storage such as a hard drive, a CDROM or a rewritable CDROM or another magnetic, optical or other media, and other associated components connected over an electronic bus, as will be appreciated by persons skilled in the art. Card member station 115 may be equipped with an integral or connectable cathode ray tube (CRT), a liquid crystal display (LCD), electroluminescent display, a light emitting diode (LED) or another display screen, panel or device for viewing and manipulating files, data and other resources, for instance using a graphical user interface (GUI) or a command line interface (CLI). Card member station 115 may also include a network-enabled appliance, a browser-equipped or other network-enabled cellular telephone, or another TCP/IP client or other device.

FIG. 2 illustrates exemplary modules that may be associated with central rewards programs station 105 for carrying out (or administering) the various functions and features of the embodiments described herein. In some embodiments, the modules may: (1) be accessed by an agent or administrator of central rewards program station 105, (2) store, maintain and administer particulars on a plurality of rewards programs that are available to card members, (3) store, maintain and administer particulars on a plurality of card members, (4) track card member transactions with a plurality of reward cards and store, maintain and administer card member transaction histories for use in identifying reward categories, (5) evaluate a card member's existing reward categories against alternative reward categories based on particulars about the card member, card member's transactions, or any other data or information that may demonstrate the card member's needs, (6) dynamically enroll a card member in particular reward category(s) that better relate to the card member's transaction or reward category history or demonstrated interest; (7) prioritize or order a card member's reward categories based on the card member's transaction or reward category history or demonstrated interest; (8) convert reward value between reward categories, and (9) store, maintain and administer reward conversion rates. Other features and functionality are of course possible. While the modules may not be used in all embodiments to perform some or all of the functions of the present invention, they are nonetheless presented as possible embodiments:

Rewards program module 205 may, in some embodiments, process and maintain data and information relating to reward categories that are available to card members. For example, reward categories may be stored and maintained by category, such as cash-back programs, proprietary programs (e.g., programs administered by the issuer of the card, loyalty programs (e.g., cards that are branded and reward loyalty to the sponsor), or any other type or category of rewards that may be used to identify and offer reward categories according to the systems and methods described herein. Reward categories may also be stored by good or device or by category of good or service. For example, a reward category may be associated with a particular product (e.g., as identified by SKU number), by retailer or merchant name, or by a general category, such as “grocery stores,” for example. Other techniques for categorizing are of course possible.

Customer module 210 may, in some embodiments, process and maintain data and information relating to customers of a card issuer or sponsor, such as, for example, the identity of the customer, the location (e.g., residential or work address) of the customer, the customer's preferred or favorite merchants, products or services, the card(s) associated with the customer, the reward categories associated with the customer, or any other biographical or demographic information that may be used to dynamically identify, prioritize or order relevant reward categories to the customer according to the systems and methods described herein. In some embodiments, customer module 205 may cooperate with rewards program module 210 to associate particular customers with particular reward categories to enable the various systems and methods described herein to dynamically identify and offer reward categories that are relevant and of interest to card members.

Customer history module 215 may, in some embodiments, process and maintain data and information relating to card member transactions carried out via reward cards and/or reward categories. For example, customer history module 215 may, for a particular customer or card member, any and all transactions (e.g., purchases) that the card member has processed using a particular card, including the date of the transaction, the identity of the merchant or vendor, the amount of the transaction, the location of the transaction, the goods or services purchased (e.g., identified by SKU number), the reward value earned (e.g., redeemable points, cash, sponsor or issuer redeemable value), or any other data or information that may be used to classify the transaction in such a way that it may be used to identify and offer reward categories according to the systems and methods described herein. In some embodiments, customer history module 215 may also process and maintain data and information relating to card member reward redemptions carried out via reward cards and/or reward categories. For example, a card member that routinely redeems reward value for cash rather than for a particular product or service may indicate a preference for reward categories that offer cash over those that offer products or services.

Rewards program evaluation module 220 may, in some embodiments, evaluate a card member's particulars (e.g., data or information from customer history module 215) and dynamically identify and offer rewards programs that may be of particular interest or relevance to the card member. In some embodiments, card member particulars may comprise customer information, transaction history or reward category history (e.g., redemption history, reward earnings history, earning levels, reward categories, currency type (e.g., points, miles or cash), or any other particular related to a reward category), merchant or vendor information, and any information or data that may be used to identify relevant reward categories as described herein. In some embodiments, upon the occurrence of an event that triggers the dynamic identification, prioritization or ordering of reward categories (e.g., the periodic processing of transaction or reward category information, such as for purposes of preparing and generating a monthly statement of transactions), rewards program evaluation module 220 may resolve card member particulars against rules or algorithms to identify reward categories that may be of general or particular relevance or interest to the card member. In some embodiments, some or all of the reward categories available for offering or may be administered by the administrator of central rewards programs station 105 (e.g., card issuer or sponsor), while in some embodiments some or all of the reward categories may be administered by a third party.

Prioritization module 225 may, in some embodiments, prioritize or order reward categories or components. In some embodiments, prioritization module 225 may cooperate with rewards category evaluation module 220 to prioritize or order reward categories in such a way so that the associated card member, for example, may receive rewards in a relevant and focused manner. For example, assume a card member's transaction history or reward category history reflects that the card member has made two (2) transactions with a restaurant, five (5) transactions with a gas station and three (3) transactions with a grocery store. In some embodiments, rewards category evaluation module 220 may evaluate this information and identify three reward categories that the user should dynamically earn rewards in: (1) a dining discount category, (2) a gas discount category, and (3) a grocery discount category. In some embodiments, prioritization module 225 may then prioritize or order the reward categories in a such a way that the card member realizes greater savings. For example, prioritization module 225 may associate the reward categories with discount rates, for example, according to the frequency of transactions. Thus, in the example provided, prioritization module 225 may order the rewards in such a way that the card member would get 10% discounts at gas stations, 7% discounts at grocery stores, and 5% discounts in dining. In some embodiments, the top categories of rewards may earn equivalent rewards, such as, for example, 10% discounts at gas stations, 10% discounts at grocery stores, and 10% discounts in dining. In some embodiments, prioritization module 225 may prioritize or order reward categories according to rules or algorithms that specify how such prioritizing or ordering should occur. For example, the rules may specify what type of rewards are to be administered (e.g., coupons, discounts, rebates, etc.), or how they are to be administered. In some embodiments, the rules may be determined by an administrator of central reward categories station 105, or by the card member himself (e.g., during registration or sign-up, the card member may specify particular preferences or selections for the dynamic identification of reward categories).

In other example, prioritization module 225 may associate reward categories based on the total amount spent by the card member, for example, on particular goods or services, or categories of goods or services. For example, assume the card member spends $135 at two restaurant outings, $233 on groceries on three occasions, and $150 at four gas stations over a one month period. In this example, as above, rewards program evaluation module 220 may evaluate this information and conclude that the user should dynamically be enrolled in: (1) a dining discount program, (2) a gas discount program, and (3) a grocery discount program. In some embodiments, prioritization module 225 may then prioritize or order the reward categories in a such a way that the card member realizes greater savings. However, in this example, prioritization module 225 may associate the reward categories with discount rates, for example, according to the total spent per category of goods or services. Thus, prioritization module 225 may prioritize or order the reward categories in such a way that the card member would get 10% discounts at grocery stores, 7% discounts at gas stations, and 5% discounts at restaurants. Prioritization module 225 may, of course, utilize any scheme, rules or algorithms to determine how reward categories are to be prioritized or ordered.

Rewards conversion module 230 may, in some embodiments, convert between rewards associated with various rewards program, or credit value to reward categories. For example, if the systems and methods described herein dynamically enroll a card member in a new rewards program, rewards conversion module 230 may convert any rewards that have been accumulated by the card member or family member or other designation individual, for example, in a previous rewards program to the equivalent reward(s) in the new reward category the card member has been switched to. In some embodiments, the conversion may be one-to-one, such that 100 reward value units (e.g., points), for example, in the initial rewards program will translate into 100 reward value units (e.g., points) in the new reward category. In some embodiments, a particular conversion rate may be referenced to calculate the appropriate translation of rewards. For example, reward category A may have a one-to-two ratio conversion with program reward B. Accordingly, if the card member had accumulated 100 value units (e.g., points) in program A, he would obtain 200 value units (e.g., points) for switching to program B. In some embodiments, rewards conversion module 230 may credit value to a reward category according the various systems and methods described herein. Other scenarios are possible.

In some embodiments, the various systems and methods described herein enable a card member to earn his or her choice of a percentage of amount spent, or a designated number of points or other quantifiable reward unit or value. For example, a card member could be given the choice of earning 3% of transaction value or three (3) points. Card member A, for example, may say he wants to earn cash, while card member B may prefer points. Even though both card members are earning different rewards, they are earning identical value and could switch between cash and points. For example, if card member B had 5,000 points he could selectively convert this amount to $50.00. In so doing, however, the dynamic nature of his spending and other transaction behavior still carries through, regardless of the actual value or rewards being realized. In some embodiments, a card member may designate particular types of transactions that should earn points and which should earn cash. For example, a card member could be notified (e.g., on his or her monthly statement) that he or she has 10,000 points or $100 that are redeemable based on reward earnings.

Conversion rate module 235 may, in some embodiment, facilitate the rewards conversion process customer transactions by storing and maintaining conversion rates between various reward categories. This way, rewards conversion module 230 may readily obtain conversion rate information when needed. In some embodiments, conversion rates administered my conversion rate module 235 may be administered and revised by an agent of central rewards program station 105, for example.

Administration module 240 may, in some embodiments, enable an administrator of central rewards program station 105, for example, to interact with the various modules, features and functionality described herein. For example, an agent of central rewards program station 105 may interact with administration module 240 to input, revise and remove data and information used by the various systems and methods described herein, such as, for example, card member information, reward category information, conversion rate information, or any other data or information that may be used to identify and offer reward categories to customers as described herein. In some embodiments, administration module 240 may enable an administrator of central rewards station 105 to establish parameters or rules associated with the various features and functionality described herein. For example, an administrator may establish limits, caps, delays, vintage reward rules (e.g., vintage reward rule(s) may be established that specifies how aged rewards are to be treated—for example, a reward that has been in effect for two years may automatically expire; other rules may of course be established depending on specific business needs) or fees associated with a card member's use of the features and functionality described herein. Thus, a card member may be limited to a predetermined number of transactions (e.g., reward category switches) over a predetermined period of time, such as annually or monthly, for example. Other predetermined periods of time are of course possible. A card member may also be required to pay a fee to be able to be able to switch between reward categories. Such a fee may be, for example, annually or monthly imposed or may be charged on a one-time or per-transaction basis. In some embodiments, the fee may comprise a monetary amount or any other form of measurable value. In some embodiments, delays may be imposed to verify that a particular exchange or movement of points was done properly and in good-faith (e.g., accrue points before they are actually available for redemption).

Recommendations module 250 may, in some embodiments, present the user with recommended or suggested reward category(s) that may be of relevance based on the user's transaction or reward category history, for example. In some embodiments, the recommendations may also be made based on the user's future activity, behavior or transactions. For example, the user may specify that he intends to go to Orlando, Fla. for a week-long vacation in a months time. The various systems and methods described herein may then recommend or suggest particular reward categories that may be relevant to the user's trip. In some embodiments, the user may be automatically enrolled in the recommended or suggested programs, while in some embodiments the user may be asked if he wants to enroll.

User input module 250 may, in some embodiments, permit a user to interact with the various systems and methods described herein to provide necessary data and information. For example, user input module 250 may process user input relating to recommended or suggested reward categories. User input module 250 may also process user input relating to future activity, behavior or transactions.

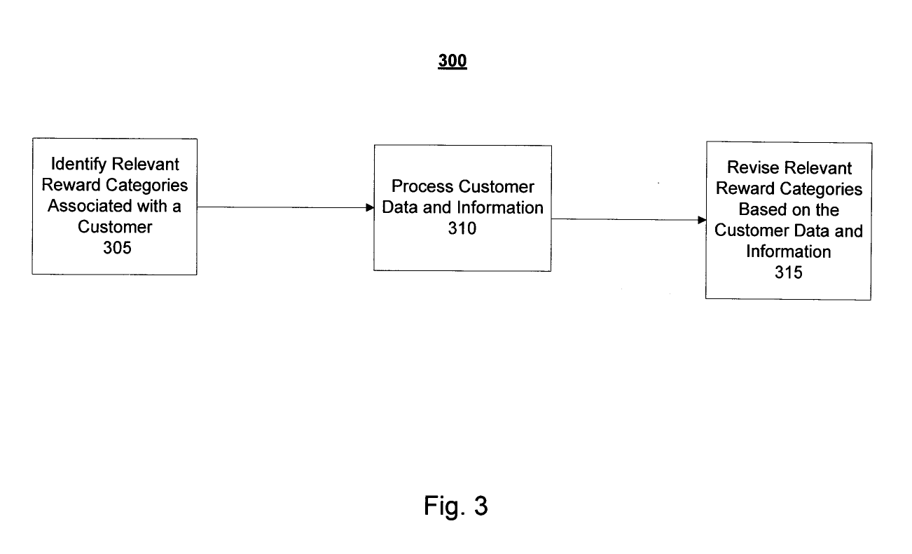

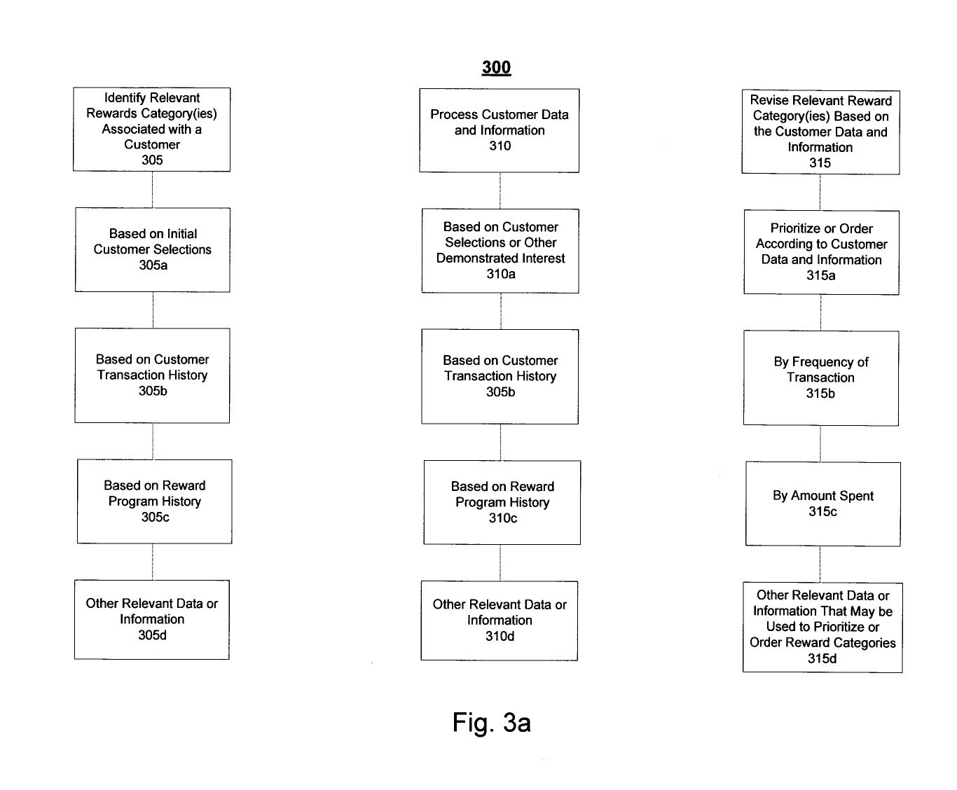

FIG. 3 illustrates a process flow 300 for identifying, prioritizing and offering reward categories, according to an embodiment of the systems and methods described herein. At step 305, relevant reward category(s) associated with a customer may be identified. Associated reward categories may comprise any reward category(s) that the card member is currently enrolled in. Identification may occur in several ways. For example, identification may occur as part of the process for generating transaction statements (e.g., monthly transaction statements) for a particular card member. In some embodiments, identification may result from the card member calling the card-issuer, for example, to inquire about a balance or make payment on the account, for example. In some embodiments, identification may also occur as a result of the card member accessing the card-issuer's web site to obtain information about the card and/or its services, or to otherwise interact with the card issuer on any matter associated with the card, such as, for example, making payment on the account or obtaining a credit line increase. In some embodiments, identification may occur as a result of periodic verifications by a card issuer, for example, of its card member reward category status. In some embodiments, the step of identifying relevant reward categories(s) associated with a card member need not be performed for purposes of carrying out the various features and functionality described herein. For example, the process of identifying, prioritizing and offering reward categories to a card member may be performed regardless of the types of reward categories the card member is currently enrolled in or is otherwise associated with.

At step 310, data or information about the card member may be processed to determine particular reward category(s) that may be of interest to the card member. In some embodiments, data or information about the card member may comprise transaction data or information corresponding to the card member's recent purchases or reward category activity. For example, the various systems and methods described herein may determine particulars about a card member's past transaction history or reward category history (e.g., redemption history, reward earnings history, earning levels, reward categories, currency type or selections (e.g., points, miles or cash), or any other particular related to a reward category) to develop a sense of the card member's interests or needs. In some embodiments, central reward category station 105—in particular the various modules described in FIG. 2—may process the data or information of the card member and identify at least one reward category(s) that may be relevant to the card member's past transaction history or reward category history (e.g., redemption history, reward earnings history, earning levels, reward categories, currency type (e.g., points, miles or cash), or any other particular related to a reward category). In some embodiments, central reward category station 105 may automatically process data or information about a card member in connection with generating a monthly or other period statement of transactions. For example, a card issuer may determine relevant reward category(s) that may be of relevance to a card member based on transaction data or information appearing on the card member's monthly statement.

In some embodiments, the determination of whether a particular reward category is relevant to card member may be based on the issuing entity's assessment of the user. Such assessment may comprise any factors or aspects of the user's relationship with the bank, transaction or reward category history that may be used to identify relevant reward categories. In some embodiments, the card member may unilaterally select the specific or categories of reward category(s) he or she is interested in joining, such as by interacting with particular tools provided by an issuing entity (e.g., a bank or other entity or individual that is administering reward category(s)), for example. Such designations or preferences may be designated by the card member during a registration or enrollment with a program that dynamically enrolls the card member in reward category(s) as set forth herein.

At step 315, upon having at least one reward category(s) that is of relevance to the card member, rewards program evaluation module 220 may then revise the reward category(s) associated with the card member to include at least one relevant reward category(s) that may better suit the card member's needs or demonstrated interests. For example, if the card member is currently enrolled in a rewards program that rewards value units (e.g., points) for purchases made at a particular retail outlet, which the card member rarely ever shops at, reward category evaluation module 220 may identify another retail outlet that better fits the card member's demonstrated shopping patterns.

The processing described in FIG. 3 may involve the transfer of value from one reward category to another. In some embodiments, value may be switched between reward categories associated with different reward category entities. For example, an initial value to be converted may correspond to a rewards program administered by a first bank, while the switched or converted-to value may correspond to a rewards program administered by a second bank. In some embodiments, converting between such reward categories may involve interfacing with an internal or external “value” bank that maintains and administers value (e.g., points) balances associated with different reward categories with any number of reward category entities. For example, central rewards program station 105 administered by a first bank may interface with such a value bank to determine how much value a potential customer has with a rewards program administered by a second bank. The first bank may then use this information to determine the appropriate conversion rate, for example, or how to otherwise convert to value associated with one of its own reward categories. In some embodiments, access to the value bank may be controlled with appropriate security controls (e.g., username and password) to prevent fraud or unauthorized access to such data and information. Thus, a bank soliciting a potential client may access the value bank to verify the potential customer's value balance with a particular reward category associated with another bank, for example. In some embodiments, central rewards program station 105 may also deduct the value (e.g., points) associated with the other bank's reward category to ensure that the potential customer does not subsequently redeem the value with the other bank. In some embodiments, access to the value bank may require appropriate contractual relations with the administer of the value bank, the potential customer, and/or the entity program administering the potential customer's reward category to ensure proper authorized access to such information. In some embodiments, the value bank may also be used to convert value units (e.g., points) between reward categories associated with a single reward entity.

In some embodiments, the various systems and methods described herein may be used to pool value accumulated through a plurality of reward categories and transfer them to any number of reward categories. For example, a customer having 100 value units (e.g., points) accumulated on a theme-park card, 50 value units (e.g., points) on an airline card, and 25 value units (e.g., points) on a gas station card, may transfer some or all of the accumulated value onto a single rewards program or any number of rewards programs. Thus, the 150 points associated with the theme-park and airline cards may be converted and transferred onto the gas station card. In another example, the 50 points associated with the airline card may be transferred to the theme-park and gas station cards in equal (e.g., 25 and 25) or other predetermined amounts (e.g., 35 for the theme-park card and 15 for the gas station card). In some embodiments the collective 150 points may be credited onto a new reward category. For example, the 150 points may remain with the customer, but a new program may be created which credits rewards to the customer based on the 150 accumulated points. Other conversion and transfer schemes are of course possible.

In some embodiments, the various systems and methods described herein may be transfer accumulated value (e.g., points) from one individual to another, regardless of the reward categories involved. For example, person A may have 100 points accumulated with reward category A. Person A may transfer 50 of his points, for example, to Person B who is associated with rewards program B. In some embodiments, accumulated points may also be transferred to specific individuals within a rewards program. For example, a father enrolled in a rewards program associated with a gas card and having 100 points of value, for example, may designate that 25 points be transferred to his daughter and that 25 points be transferred to his son. In some embodiments, the transferred points may be stored in or associated with a sub-account associated with the rewards program and/or the transferee (e.g., son and daughter).

FIG. 3a illustrates types of data or information that may be referenced to carryout the specific functionality of the process flow shown in FIG. 3. For example, step 305 for identifying reward categories that are associated with a customer may be based on initial customer selections or preferences 305a. In some embodiments, such selections or preferences may be designated when the customer is enrolling or sign-in up for the dynamic enrollment services described herein. For example, a card member may designate a preference for reward categories that offer cash-back rather than points or other non-monetary value. In such a case, the various systems and methods described herein would only identify, recommend, suggest or dynamically enroll the customer in reward categories that provide cash-back rewards. Other customer designations, selections or parameters are of course possible. In some embodiments, relevant reward categories may also be identified based on the customer's transaction history 305b (e.g., as determined from the customer's monthly statement), reward category history 305c (e.g., as determined from the customer's redemption patterns), or any other data or information 305d that may be used to particularly identify reward categories that are of relevance to the customer.

Similarly, the processing of customer data and information in step 310 may also be based on customer selections 310a, customer transaction history 310b, reward category history, or any other data or information 305d that may be used to particularly identify reward categories that are of relevance to the customer. The step of revising the customer's relevant reward category(s) may comprise adding or deleting particular reward category(s) and prioritizing or ordering reward category(s) according to customer data or information 315a. In some embodiments, adding or deleting reward category(s) or prioritizing or ordering reward category(s) may be based the frequency of particular transactions over a period of time 315b, by amount spent on particular transactions over a period of time, or any other data or information 305d that may be used to add, delete or prioritize or order reward category(s) according to the systems and methods described herein.

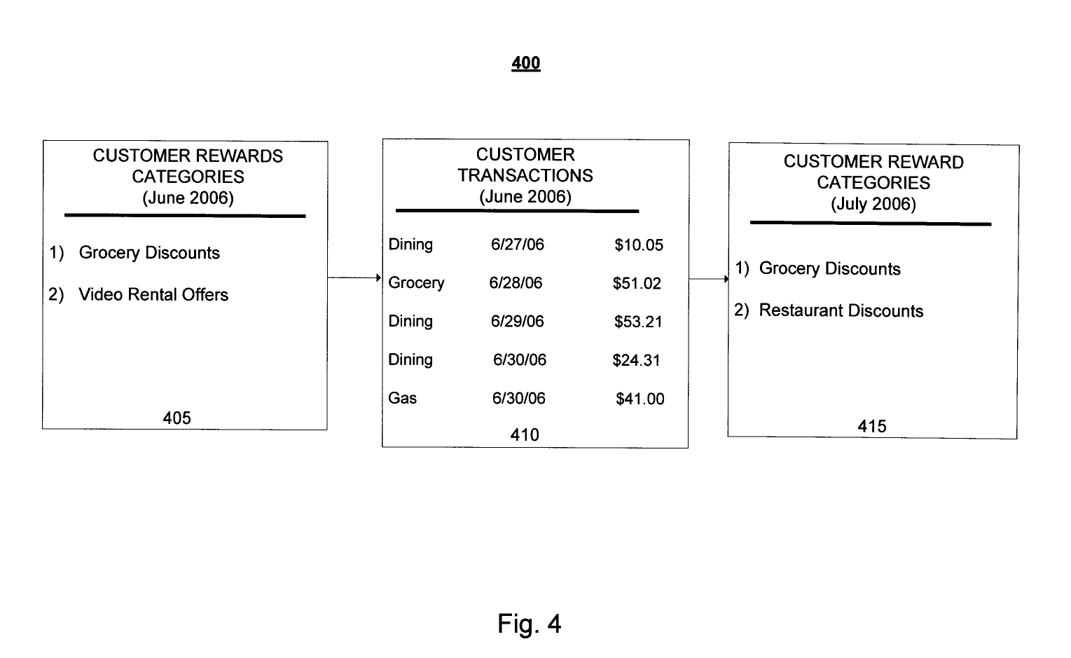

FIG. 4 illustrates an exemplary process flow 400 for identifying, prioritizing and offering reward categories, according to an embodiment of the systems and methods described herein. At step 405, central rewards program station 105 may identify rewards programs associated with a particular customer. As shown, the customer is associated (e.g., currently enrolled) with two reward categories during June, 2006: a grocery discount program and a video rental offer program. At step 410, central rewards program station 105 may process customer data and information to determine demonstrated user interest or needs. In some embodiments, the customer data may comprise, as shown, transaction data used to generate the customer's monthly statement. In this example, the customer has entered into three (3) dining transactions, one (1) grocery transaction, and one (1) gas transaction, all in the month of June. At step 415, central rewards program station 105 may then revise the customer rewards programs to conform with the demonstrated user interest exemplified by the transaction history for June, 2006. Accordingly, as shown in FIG. 4, central rewards program station 105 may dynamically enroll the customer in the restaurant discount reward category as a result of the high frequency with which the user frequented restaurants during the month of June. In some embodiments, central rewards program station 105 may, as shown, simply add the restaurant discounts to the list of customer reward categories. In some embodiments, central reward category station 105 may also remove any reward categories that did not have associated activity during the period of time under consideration (e.g., the video rental offers reward category). In some embodiments, central rewards program station 105 may also prioritize or order the reward categories as described herein.

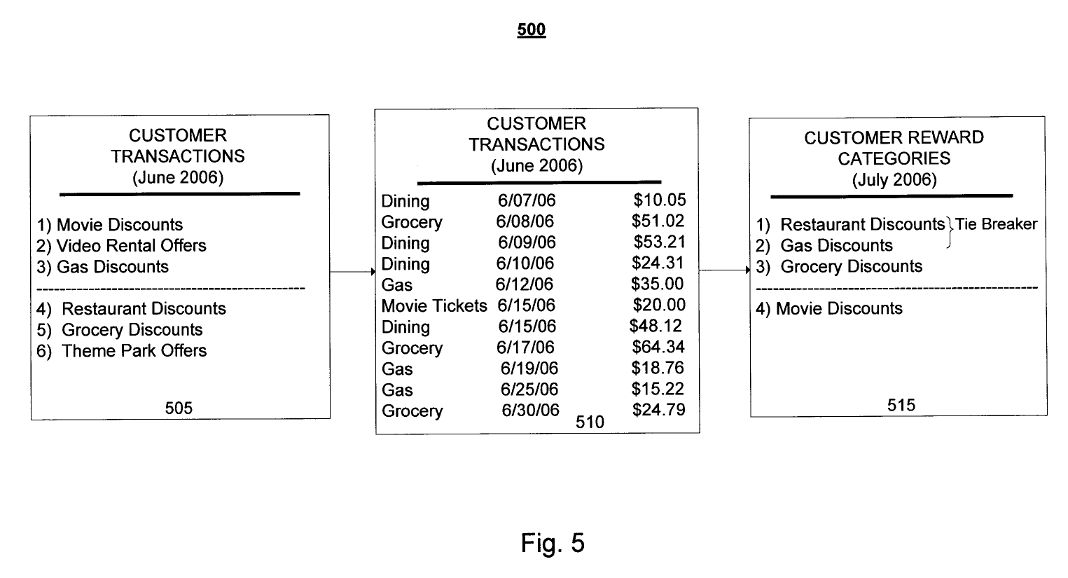

FIG. 5 illustrates an exemplary process flow 500 for identifying, prioritizing and offering reward categories, according to an embodiment of the systems and methods described herein. At step 505, the customer is determined by central reward station 105 to be associated with six (6) reward categories: (1) a movie discount program, (2) a video rental program, (3) a gas discount program, (4) restaurant discounts program, (5) grocery discounts program, and (6) theme park offers program. In some embodiments, as shown, some of the reward categories that a customer is associated with are active (e.g., (1)-(3)), while some are inactive (e.g., (4)-(6)). In some embodiments, only reward categories that are active are applied against the customer's transactions for purposes of determining rewards.

At step 510, the customer's transactions may be determined by central reward station 105. As shown, the customer conducted the following transactions during the month of June: (1) four gas transactions, (2) three grocery transactions, (3) three gas transactions, and (4) one movie transaction. In some embodiments, an administrator of system 105, for example, may add or delete individual transactions from the list in 510. This would allow a particular merchant to more specifically designate what categories a particular transaction should be in. For example, a particular franchise restaurant at location A may be treated differently than the same franchise restaurant B. The ability to add or delete transactions permits the merchants or the administrator to selectively influence the ordering of customer reward categories. At step 515, central reward station 105 may revise the listing of reward categories associated with the customer against the transaction data obtained for the month of June. In some embodiments, revisions to the listing of associated reward categories may be based on any rules or regulations that specify how transaction data and information is to be processed. For example, revisions can be based on the frequency of transactions or the total amount spent on particular goods or services, for example. As shown, the customer reward categories have been prioritized or reordered according to frequency of transaction so that restaurant discounts is listed first followed by gas discounts and grocery discounts in second and third place, respectively. In some embodiments, when there is a tie between two types of transactions (e.g., as between gas and grocery transactions), predetermined rules may be used to specify which of the transactions will receive priority (e.g., gas discounts in FIG. 5). In some embodiments, reward categories that have not seen activity during the predetermined period of time (e.g., video rental discounts) may be removed from all listings, or placed into inactive status (e.g., movie discounts). In some embodiments, the customer's reward categories may be reevaluated once the next

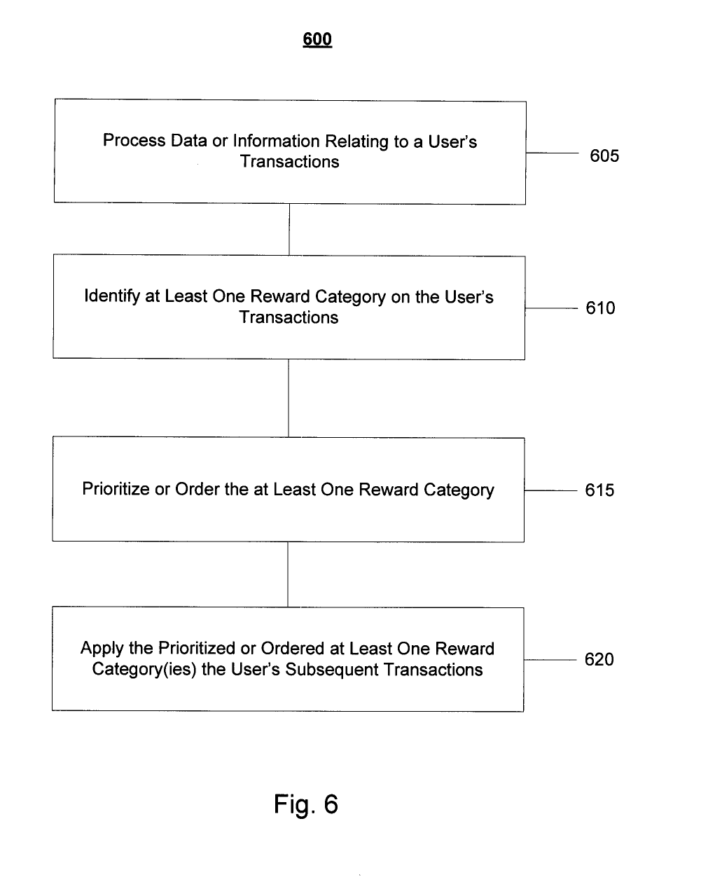

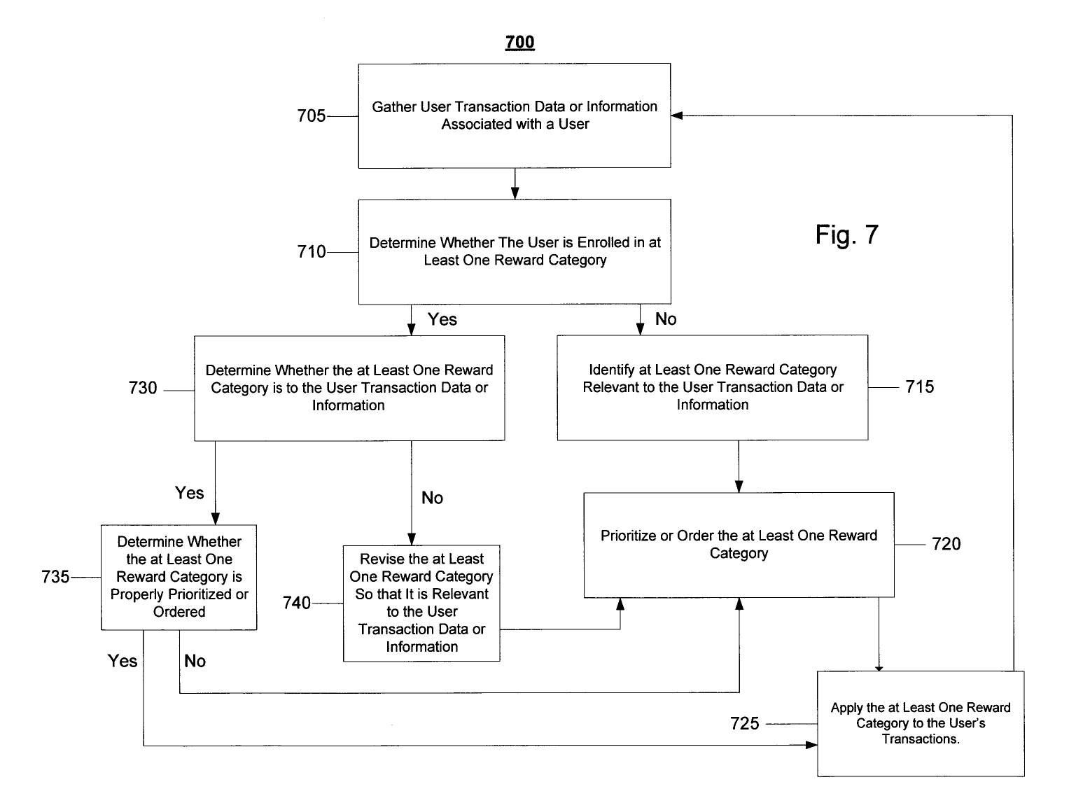

FIGS. 6 and 7 generally illustrate typical process flows performed by the systems described herein for identifying and offering rewards programs:

FIG. 6 illustrates a process flow 600 for dynamically identifying, prioritizing and offering at least one reward category, according to an embodiment of the invention. At step 605, data or information relating to a user's transactions are processed. At step 610, at least one reward category based on the user's transactions is identified. At step 615, the at least one reward category is prioritized or ordered. At step 620, the prioritized or ordered at least one reward category is applied to the user's subsequent transactions.

FIG. 7 illustrates a process flow 700 for dynamically identifying, prioritizing and offering reward categories, according to various embodiments of the invention. At step 705, user transaction data or information associated with a user is gathered. At step 710, a determination is made whether the user is enrolled in at least one reward category. If yes, at step 730 a determination is made whether the at least one reward category is related to the user transaction data or information. If yes, then at step 735 a determination is made whether the at least one reward category is properly prioritized or ordered. If yes, then at step 725, the at least one reward category is applied to the user's transaction. After a predetermined period of time (e.g, monthly), the process begins anew at step 705.

Referring back to step 730, if, however, the at least one reward category is not relevant to the user's transaction data or information, then at step 740 the at least one reward category is revised so that it is relevant to the user's transaction data or information. In some embodiments, such revision may comprise identifying at least one reward category that is relevant to the user's transaction data or information. At step, 720 the at least one reward category that is relevant to the user's transaction data or information is prioritized or ordered. Next, at step 725 the at least one reward category is applied to the user's tractions. After a predetermined period of time (e.g, monthly), the process begins anew at step 705.

Referring back to step 710, if, however, the user is not enrolled in at least one reward category, then at step 715 at least one reward category relevant to the user transaction data or information is identified. Next, at step, 720 the at least one reward category that is relevant to the user's transaction data or information is prioritized or ordered. Next, at step 725 the at least one reward category is applied to the user's tractions. After a predetermined period of time (e.g, monthly), the process begins anew at step 705.

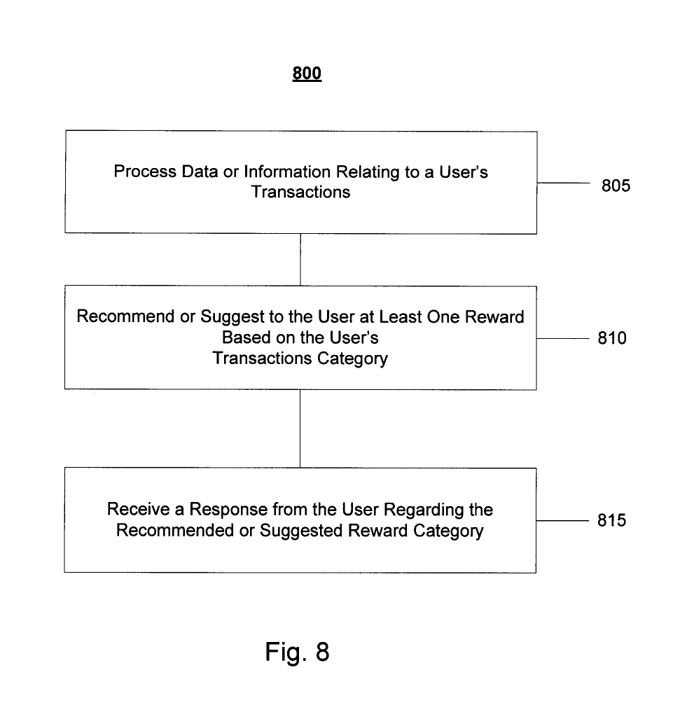

FIG. 8 illustrates a process flow 800 for offering rewards programs or categories, according to various embodiments of the invention. At step 805, data or information relating to a user's transactions are processed as described herein. At step 810, at least one reward category is recommended or suggested to the user based on the user's transactions. At step 815, a response from the user is received relating to the recommended or suggested reward category. In some embodiments, the response may be a request to enroll the user in the recommended or suggested reward category.

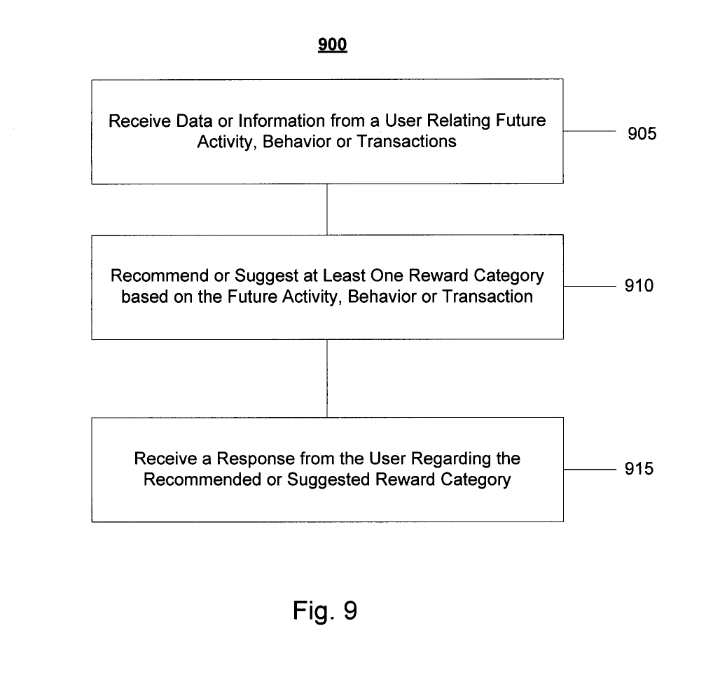

FIG. 9 illustrates a process flow 900 for offering rewards programs or categories, according to various embodiments of the invention. At step 905, data or information relating to a user's future activities, behavior or transactions is received. At step 910, at least one reward category is recommended or suggested to the user based on the user's future activities, behavior or transactions. At step 915, a response from the user is received relating to the recommended or suggested reward category. In some embodiments, the response may be a request to enroll the user in the recommended or suggested reward category.

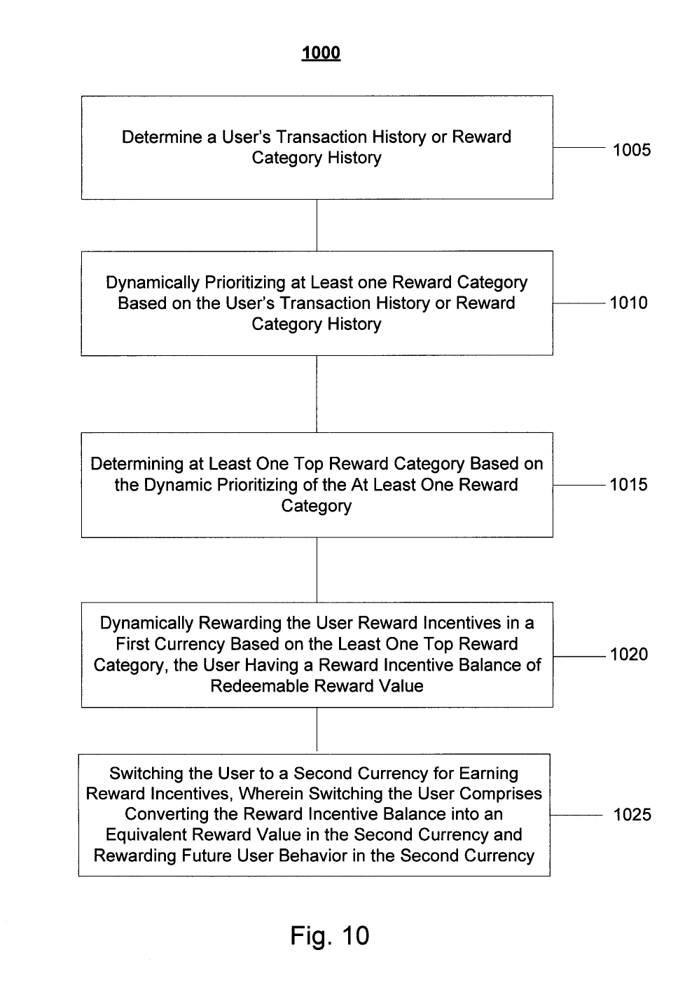

FIG. 10 illustrates a process flow for identifying and offering rewards, according to various embodiments of the invention. At step 1005, a user's transaction history or reward category history is determined. At step 1010, at least one reward category based on the user's transaction history or reward category history is dynamically prioritized. At step 1015, at least one top reward category based on the dynamic prioritizing of the at least one reward category is determined. At step 1020, user reward incentives are dynamically rewarded in a first currency based on the least one top reward category, the user having a reward incentive balance of redeemable reward value. At step 1025, the user is switched to a second currency for earning reward incentives, wherein switching the user comprises converting the reward incentive balance into an equivalent reward value in the second currency and rewarding future user behavior in the second currency.

The embodiments of the present inventions are not to be limited in scope by the specific embodiments described herein. For example, although many of the embodiments disclosed herein have been described with reference to rewards programs, the principles herein are equally applicable to the any type of program, rewards or otherwise, that may enroll customer or users. In addition, although many of the embodiments disclosed herein have been described with reference to a central rewards program station that is associated with a card issuer, such as a bank, for example, it should be appreciated that various aspects of the invention may be accomplished when various system components are located elsewhere. For instance, the central rewards program station described herein may be maintained and administered by a third party service provider. Indeed, various modifications of the embodiments of the present inventions, in addition to those described herein, will be apparent to those of ordinary skill in the art from the foregoing description and accompanying drawings. Thus, such modifications are intended to fall within the scope of the following appended claims.

Further, although the embodiments of the present inventions have been described herein in the context of a particular implementation in a particular environment for a particular purpose, those of ordinary skill in the art will recognize that its usefulness is not limited thereto and that the embodiments of the present inventions can be beneficially implemented in any number of environments for any number of purposes. Accordingly, the claims set forth below should be construed in view of the full breadth and spirit of the embodiments of the present inventions as disclosed herein.

According to various embodiments, the systems and methods described herein may provide customers with the ability to change the rewards they earn. For example, customers, new or existing, have the option to choose what kind of reward they earn-points or cash back. The key element is that once customers choose their reward option, they can switch back and forth between points or cash depending upon what makes most sense for them at that time. In addition, the new structure allows customers to earn more. Take following is an embodiment of a cash back option:
Customers choosing the cash back option earn three percent cash back for every $1 spent on grocery, gas and fast food restaurant purchases; one percent cash back for every $1 spent on everything else.
Once $50 in rewards is earned, customers can redeem for a $50 check and once $200 in rewards is earned, customers can redeem for a $250 check.

Now, check out the points option:
Customers earn three points for every $1 spent on grocery, gas and fast food restaurant purchases, one point for every $1 spend on everything else.
Customers can redeem their points for merchandise, travel or gift certificates, starting at 1,000 points.

The various systems and methods described herein allow customers the flexibility to switch from points to cash and vice versa without forfeiting their existing rewards.

What is claimed is:

1. A method for identifying and offering rewards, comprising the steps of:
determining a user's transaction history or reward category history;
dynamically prioritizing at least one reward category based on the user's transaction history or reward category history;
determining at least one top reward category based on the dynamic prioritizing of the at least one reward category;
dynamically rewarding the user reward incentives in a first currency based on the least one top reward category, the user having a reward incentive balance of redeemable reward value; and
switching the user to a second currency for earning reward incentives, wherein switching the user comprises converting the reward incentive balance into an equivalent reward value in the second currency and rewarding future user behavior in the second currency.

2. The method of claim 1 wherein the dynamically rewarding the user reward incentives are rewarded hourly, daily, weekly, quarterly, annually, or according to any schedule, periodic, random or otherwise.
